(19) United States
(12) Patent Application Publication
(10) Pub. No.: US 2026/0037381 A1
(43) Pub. Date: Feb. 5, 2026

(54) GENERATING A METADATA CACHE FOR A BACKUP

(71) Applicant: Hewlett Packard Enterprise Development LP, Spring, TX (US)

(72) Inventors: Anoop Kumar Raveendran, Bangalore (IN); Viswesvaran Janakiraman, San Jose, CA (US); Rachit Gupta, Bangalore (IN); Jothivelavan Sivashanmugam, Bangalore (IN)

(21) Appl. No.: 18/926,657

(22) Filed: Oct. 25, 2024

(30) Foreign Application Priority Data
Aug. 4, 2024 (IN) 202411058850

(51) Int. Cl. G06F 11/14; G06F 13/16

(52) U.S. Cl. CPC G06F 11/1435; G06F 11/1451; G06F 13/1673

(57) ABSTRACT

Example implementations relate to computer data storage. In some examples, a metadata scanner identifies files in a filesystem, wherein each file comprises logical blocks, and where the filesystem is included in a backup. The metadata scanner issues a read call for a logical block. A filesystem layer translates the read call into a set of translated read calls. For each translated read call, a metadata extractor determines whether the translated read call is to read a metadata block. In response to a determination that the translated read call is to read the metadata block, the metadata extractor obtains the metadata block from a persistent storage device, and stores the obtained metadata block in a metadata cache.

### BACKGROUND

Computing devices may include components such as a processor, memory, caching system, and storage device. The storage device may include a hard disk drive that uses a magnetic medium to store and retrieve data blocks. Some storage systems may transfer data between different locations or devices. For example, some systems may transfer and store copies of important data for archival and recovery purposes.

### BRIEF DESCRIPTION OF THE DRAWINGS

Some implementations are described with respect to the following figures.

FIG. 1 is a schematic diagram of an example system, in accordance with some implementations.

FIGS. 2A-2B are illustration of example data structures, in accordance with some implementations.

FIG. 3 is an illustration of an example process, in accordance with some implementations.

FIG. 4 is a schematic diagram of an example computing device, in accordance with some implementations.

FIG. 5 is an illustration of an example process, in accordance with some implementations.

FIG. 6 is a diagram of an example machine-readable medium storing instructions in accordance with some implementations.

FIG. 7 is a schematic diagram of an example system, in accordance with some implementations.

FIG. 8 is an illustration of an example process, in accordance with some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a storage system may store data units in persistent storage. Persistent storage can be implemented using one or more of persistent (e.g., nonvolatile) storage device(s), such as disk-based storage device(s) (e.g., hard disk drive(s) (HDDs)), solid state device(s) (SSDs) such as flash storage device(s), or the like, or a combination thereof. As used herein, a “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, a “controller” can refer to a combination of a hardware processing circuit and machine-readable instructions (software and/or firmware) executable on the hardware processing circuit.

In some examples, a collection of data may be specified in terms of one or more elements of a filesystem. As used herein, a “filesystem” is a system for organizing data that is stored in a storage device. For example, a filesystem may include a collection of data files stored in a hierarchy of directories (e.g., including a root directory and one or more levels of sub-directories). In order to present the data as a collection of data files and directories, the filesystem may maintain structures of metadata. The term “metadata,” in the context of a filesystem, refers to information that describes volumes, files and directories, but this information is not part of the stored data files. For example, the following information items describe a data file and are considered as part of the file's metadata: a file name, file size, creation time, last access/write time, user id, and block pointers that point to the actual data of the file on a storage device. Information items that compose metadata of a directory mainly include names and references to data files and sub-directories included in the directory.

In some examples, a collection of data (e.g., data files and metadata of a filesystem) may be stored on a block-based storage device. As used herein, a “block-based” storage device may refer to a device that stores data at a block level. In examples described herein, the term “block level” refers to a level of data storage that is below a file and directory level of data storage. In such examples, a block level may be a level at which a block-based storage device may store data thereon, and a level upon which files and directories are implemented by a filesystem. The block-based storage device may receive the data blocks making up a collection of data as a stream of data blocks.

In some examples, a backup process of a computing system may include copying data blocks stored in a storage device (e.g., a storage array) to a backup device that may store the data blocks in the form of a backup. In examples described herein, a “backup” may refer to a form in which a backup device stores a collection of data, which may be different from a form in which the data blocks are stored on a storage device (e.g., storage array) from which they are being backed up. For example, a backup may comprise a deduplicated representation of the data blocks copied to the backup device for backup. In some examples, a backup process may copy, to a backup device, a specified collection of data that is stored on a storage device in files and directories of a filesystem.

In some examples, the specified collection of data to be copied to the backup device may comprise one or more volumes of a storage device, some or all contents of a filesystem in which data is stored on a storage device (e.g., all data stored under a given directory, such as a root directory or one or more sub-directories), or the like. When generating a full backup, a backup process may copy all data blocks of the specified collection of data to the backup device (which the backup device may store as a backup referred to as a “full backup” herein). When generating an incremental backup, a backup process may copy exclusively the data blocks of the specified collection of data that have changed since a prior backup, and the backup device may store these changed blocks in a form referred to as an “incremental backup” herein. As used herein, a “snapshot” may be a representation of the data included in storage volume(s) (or other collection(s) of data) at a particular point in time. For example, a full backup may represent a snapshot at an initial point in time, and the combination of the full backup and an incremental backup may represent a different snapshot at a later point in time.

In some examples, it may be useful to read the metadata of a filesystem stored in a backup. For example, the metadata may be used to generate a list of files in a filesystem. In another example, the metadata may be used to determine whether a particular file is stored in a filesystem. In yet another example, the metadata may be used to scan for malicious attacks (e.g., by checking modification dates to check for a ransomware attack). However, in some examples, accessing the metadata stored in the backup may consume significant amounts of processing time and networking bandwidth. For example, accessing the metadata may require retrieving all data and metadata blocks from a block-based storage device, mounting the filesystem from the retrieved blocks, so forth.

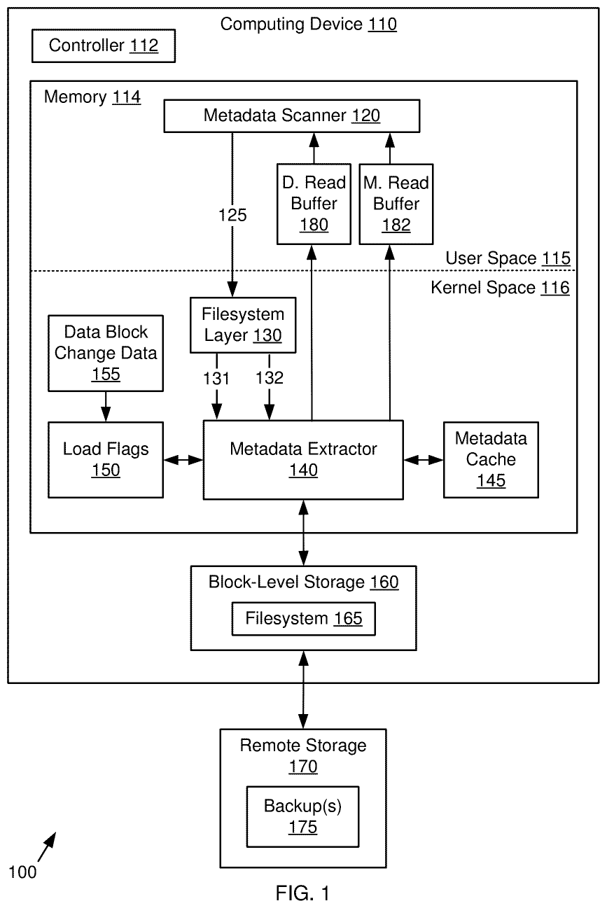

In accordance with some implementations of the present disclosure, a computing device may execute a scanner and an extractor to generate a local metadata cache. The local metadata cache includes only the metadata blocks of a filesystem that is stored in a backup. The scanner may identify each file in a filesystem, and may issue data reads to retrieve the data blocks in the identified files. Further, the scanner may generate a read buffer for each data read, and may write a metadata signature into each read buffer. A filesystem layer or module (e.g., included in the operating system) of the computing device may receive the data reads, and may generate metadata reads (associated with the requested blocks) and their respective read buffers. The extractor receives each (metadata and data) read, and determines whether the corresponding read buffer includes the metadata signature. If the metadata signature is present in the read buffer (e.g., for a data read), the extractor sets a flag to mark the corresponding data read as complete without retrieving the requested data block. Otherwise, if the metadata signature is not present in the read buffer (e.g., for a metadata read), the extractor reads the corresponding metadata block from the stored backup, and then stores the metadata block in the metadata cache. In this manner, the computing device populates the metadata cache with the metadata blocks of the filesystem, but does not read the data blocks of filesystem. Accordingly, the disclosed technique may reduce the processing time and networking bandwidth needed to obtain the metadata blocks of the filesystem stored in the backup. Various aspects of the disclosed technique are discussed further below with reference to FIGS. 1-6.

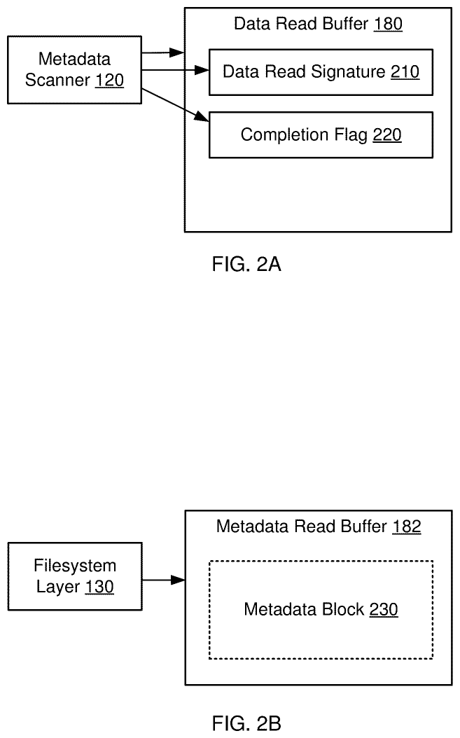

FIGS. 1-2B—Example system

FIG. 1 shows an example system 100, in accordance with some implementations. The system 100 may include an example computing device 110 and remote storage 170. The computing device 110 may be a physical computing device (e.g., server, appliance, desktop, etc.), a virtual computing device (e.g., virtual machine, container, etc.), and so forth. The computing device 110 may be coupled (e.g., via network link) to a remote storage 170. The remote storage 170 may persistently store a backup 175 (or multiple backups 175) in the form of data blocks (e.g., in deduplicated form). Each backup 175 may represent the state of a given filesystem (or a volume including a filesystem) at a different point in time (e.g., at the time of the most recent backup operation of a volume). For example, in some implementations, a backup 175 may include the data blocks and metadata blocks included in a filesystem, as they existed at a particular point in time.

In some implementations, the computing device 110 may include a controller 112, memory 114, and block-level storage 160. The controller 112 may be implemented via hardware (e.g., electronic circuitry) or a combination of hardware and programming (e.g., comprising at least one processor and instructions executable by the at least one processor and stored on at least one machine-readable storage medium). The memory 114 may be implemented in semiconductor memory such as random access memory (RAM). In some implementations, the memory 114 may include a user space 115 and a kernel space 116. The user space 115 may be a portion of the memory 114 that stores user processes being executed by the controller 112. Further, the kernel space 116 may be a portion of the memory 114 that stores an operating system kernel being executed by the controller 112. The block-level storage 160 may be implemented using non-transitory storage media (e.g., hard disk drives, solid state drives), non-volatile semiconductor memory (e.g., flash memory), and so forth.

In some implementations, the computing device 110 may host or execute a metadata scanner 120, a metadata extractor 140, an operating system (not shown in FIG. 1), and any number of other components. The metadata scanner 120 and the metadata extractor 140 may be implemented by the controller 112 executing instructions (e.g., software and/or firmware) that are stored in a machine-readable storage medium, in hardware (e.g., circuitry), and so forth. In some implementations, the metadata scanner 120 may be executed in the user space 115, and the metadata extractor 140 may be executed in the kernel space 116. Further, in some implementations, the kernel space 116 may include a filesystem layer 130. The filesystem layer 130 may be a software component (e.g., interface, driver, kernel module, etc.) that is included in the operating system of the computing device 110, and that translates system calls between applications (e.g., in user space 115) to one or more filesystems (e.g., in kernel space 116).

In some implementations, the combination of the metadata scanner 120 and the metadata extractor 140 may be executed to generate and/or update a metadata cache 145. The metadata cache 145 may store copies of metadata blocks from a given backup 175. The metadata scanner 120 may access a backup 175 stored in the remote storage 170, and may mount, on the block-level storage 160, a filesystem 165 included in the backup 175 (e.g., by using a Linux “mount” command).

In some implementations, the metadata scanner 120 may load block change data 155 into the memory 114. The block change data 155 may be a stored data structure (e.g., a bitmap, list, etc.) that is generated along with the backup 175 (e.g., by a backup process), and that indicates whether each physical data and metadata block was changed in the backup 175 (e.g., in comparison to a previous backup). The metadata scanner 120 may use the block change data 155 to initially generate a set of load flags 150 (e.g., bit values) that indicate the physical blocks that remain to be loaded into the metadata cache 145. In some implementations, when the load flags 150 are initially generated, each physical metadata block that was changed in the backup 175 (and is thus marked as changed in the block change data 155) is not already loaded (in its changed form) in the metadata cache 145, and therefore has to be loaded (or reloaded) into the metadata cache 145. Accordingly, for each physical block that was changed in the backup 175, the metadata scanner 120 may initially set the corresponding load flag 150 to a value (e.g., True) indicating that the physical block has to be (e.g., remains to be) loaded into the metadata cache 145. Further, for each physical block that was not changed in the backup 175, the metadata scanner 120 may initially set the corresponding load flag 150 to a value (e.g., False) indicating that the physical block does not need to be loaded into the metadata cache 145.

In some implementations, the metadata scanner 120 may traverse the mounted filesystem 165 to identify each file in the mounted filesystem 165. Further, the metadata scanner 120 may use a filesystem layer 130 to identify the logical data blocks included each file. Each logical data block (LDB) may represent a corresponding physical data block (PDB) that is stored in the backup 175. As used herein, the term “physical data block” may refer to a data block having an address that represents the actual physical location of the data block in a storage device or memory, and which is used by system hardware. Further, the term “logical data block” may refer to a data block having an address that is a virtual or symbolic representation of its storage location, and which is used by software programs.

In some implementations, the metadata scanner 120 may send, to the operating system kernel, one or more read calls 125 to request the logical data blocks included in the identified files. Further, the metadata scanner 120 may generate or otherwise prepare one or more data read buffers 180 in the user space 115, where each data read buffer 180 is associated with a different read call 125. For example, each data read buffer 180 may be configured to receive a result (i.e., the requested data block) of the associated read call 125.

Referring now to FIG. 2A, in some implementations, the metadata scanner 120 may generate the data read buffer 180, and may populate the data read buffer 180 with a data read signature 210 indicating that the associated read call 125 is to read a data block. For example, the data read signature 210 may be a predefined bit sequence, text string, numerical string, and so forth. Further, the metadata scanner 120 may populate the data read buffer 180 with a completion flag 220. In some implementations, the completion flag 220 may be a Boolean value (e.g., a bit value) that indicates whether the read call 125 has been completed. In some implementations, when the data read buffer 180 is generated and populated, the metadata scanner 120 may initially set the completion flag 220 to indicate that the read call 125 is not yet completed.

Referring again to FIG. 1, in some implementations, the read call 125 may be executed using a direct input/output (I/O) mode or setting. The direct I/O mode may cause the read call 125 to retrieve data directly from storage to a buffer in user space (i.e., without using a buffer in kernel space 116). For example, when using a direct I/O mode, file data requested by the metadata scanner 120 (e.g., via a read call 125) is transferred directly from storage to a data read buffer 180 in user-space 115, thereby avoiding the use of any read buffer(s) located in the kernel space 116. In some implementations, prior to sending a read call 125 for a given file, the metadata scanner 120 may initiate the direct I/O mode for the read call 125 by opening the file using a command flag or modifier (e.g., establishing a connection to the file by issuing a Linux “OPEN” system call with an “O_DIRECT” flag).

In some implementations, the filesystem layer 130 may receive or intercept a read call 125 for a logical data block (e.g., sent from the metadata scanner 120), and may translate or convert the read call 125 into a set of translated read calls. For example, the filesystem layer 130 may translate the read call 125 into a first read 131 and a second read 132. The second read 132 may be a read request for the corresponding physical data block (i.e., the physical data block that represented by the logical data block that was requested in the read call 125). Further, the first read 131 may be a read request for a physical metadata block (or blocks) including metadata that is related to the requested data block. The filesystem layer 130 may generate a metadata read buffer 182 that is configured to receive the physical metadata block that was requested by the first read 131. For example, referring to FIG. 2B, the filesystem layer 130 generates a metadata read buffer 182 that is configured to store a metadata block 230. In some implementations, the metadata read buffer 182 is not populated with the data read signature 210 (shown in FIG. 1), thereby indicating that the associated read (e.g., first read 131 shown in FIG. 1) is to read a metadata block 230.

Referring again to FIG. 1, the metadata extractor 140 may receive the second read 132 from the filesystem layer 130. The metadata extractor 140 may then determine that the data read buffer 180 (for the received second read 132) includes the data read signature 210 (shown in FIG. 2A), thereby indicating that the second read 132 is to read a data block. Upon determining that the data read buffer 180 includes the data read signature 210, the metadata extractor 140 prevents the second read 132 from being executed (e.g., by filtering or blocking the second read 132 from being executed by the operating system kernel). Further, the metadata extractor 140 may set the completion flag 220 (in data read buffer 180) to indicate that the read call 125 has been completed. In this manner, the metadata extractor 140 may mark the read call 125 as completed, but without retrieving the requested data block from storage.

Further, as shown in FIG. 1, the metadata extractor 140 may receive the first read 131 from the filesystem layer 130. The metadata extractor 140 may then determine that the data read buffer 182 (for the received first read 131) does not include the data read signature 210 (shown in FIG. 2A), thereby indicating that the first read 131 is to read a metadata block. Upon determining that the metadata read buffer 182 does not include the data read signature 210, the metadata extractor 140 performs a look-up of the requested physical metadata block in the load flags 150, and thereby determines whether that physical metadata block still has to be loaded into the metadata cache 145 (e.g., because that physical metadata block was changed in the backup 175). If the corresponding load flag 150 is set to a value (e.g., True) that indicates that physical metadata block has to be (e.g., remains to be) loaded into the metadata cache 145, the metadata extractor 140 may allow the first read 131 to executed (e.g., by the operating system kernel) to retrieve the physical metadata block from the block-level storage 160. The metadata extractor 140 may then populate the retrieved physical metadata block into the metadata cache 145. Further, the metadata extractor 140 may then set the corresponding load flag 150 to a value (e.g., False) indicating that the physical metadata block does not need to be loaded into the metadata cache 145.

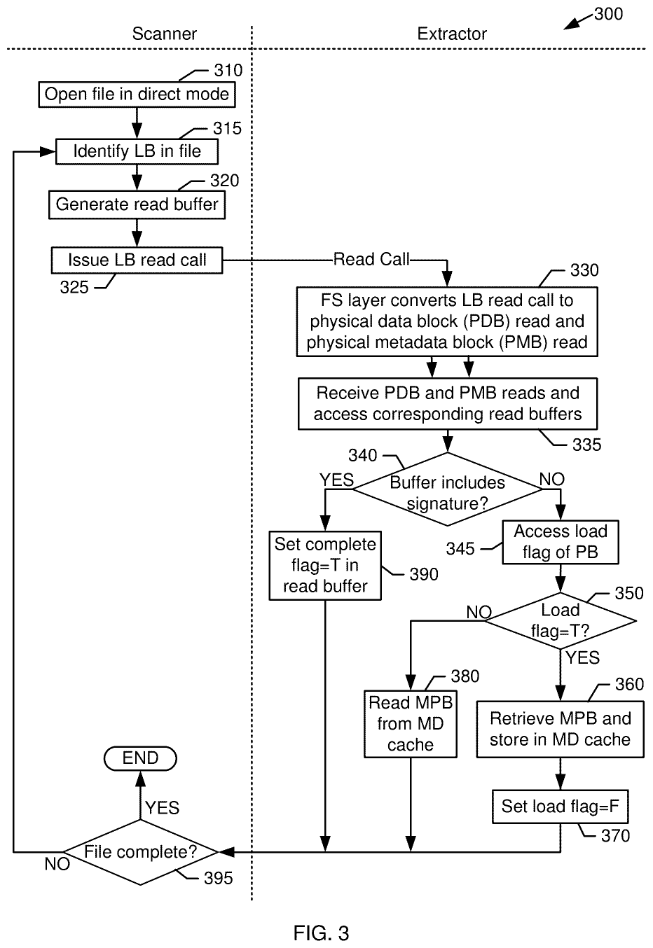

In some implementations, by processing multiple read calls 125 from the metadata scanner 120 (i.e., requesting each logical data block included in the filesystem 165), the metadata extractor 140 may generate the metadata cache 145 that stores the metadata blocks in the backup 175. An example process for generating the metadata cache 145 is described further below with reference to FIG. 3.

### FIG. 3—Example Process for Generating a Metadata Cache

FIG. 3 shows an example process 300 for generating a metadata cache, in accordance with some implementations. The process 300 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. As shown in FIG. 3, in some implementations, various actions of the process 300 may be performed by a scanner (e.g., metadata scanner 120 shown in FIG. 1) and an extractor (e.g., metadata extractor 140 shown in FIG. 1). For the sake of illustration, details of the process 300 may be described below with reference to FIGS. 1 and 2A-2B, which show some example implementations. However, other implementations are also possible.

Block 310 may include opening a file in a direct mode. Block 315 may include identifying a logical block (LB) included in the file. For example, referring to FIG. 1, the metadata scanner 120 accesses, from the remote storage 170, a backup 175 including a filesystem 175. The metadata scanner 120 mounts the filesystem 165 on the block-level storage 160 (e.g., by using a Linux “mount” command). The metadata scanner 120 traverses the mounted filesystem 165 to identify each file in the mounted filesystem 165. Further, the metadata scanner 120 selects a particular file of the mounted filesystem 165, and opens the file using a direct I/O mode (e.g., by issuing an open system call for the file using a command flag to invoke the direct I/O mode). The metadata scanner 120 then uses a filesystem layer 130 to identify the logical data blocks included the selected file.

Referring again to FIG. 3, block 320 may include generating a read buffer for the logical block. Block 325 may include issuing a read call for the logical block. For example, referring to FIGS. 1-2A, the metadata scanner 120 generates a data read buffer 180 in the user space 155, and issues a read call 125 to request the logical block. The data read buffer 180 is configured to receive the logical block that is requested by the read call 125. Further, the metadata scanner 120 populates the data read buffer 180 with a data read signature 210 and a completion flag 220.

Referring again to FIG. 3, block 330 may include the filesystem (FS) layer converting the logical block read call into a physical data block (PDB) read and a physical metadata block (PMB) read. For example, referring to FIGS. 1 and 2B, the filesystem layer 130 translates or converts the read call 125 into a set of translated read calls including the second read 132 (for a physical data block) and the first read 131 (for a physical metadata block). Further, the filesystem layer 130 generates a metadata read buffer 182 that is configured to receive the physical metadata block that was requested by the first read 131.

Referring again to FIG. 3, block 335 may include the extractor receiving the PDB and PMB reads, and accessing the corresponding read buffers. Decision block 340 may include determining, for each read, whether the corresponding read buffer includes the data read signature. If it is determined at decision block 340 that the read buffer includes the data read signature (“YES”), the process 300 may continue at block 390, including setting the complete flag, in the read buffer, to indicate that the read call is complete. After block 390, the process 300 may continue at decision block 395 (described below).

For example, referring to FIGS. 1-2A, the metadata extractor 140 receives the second read 132 (from the filesystem layer 130), and then determines that the corresponding data read buffer 180 includes the data read signature 210 (indicating that the second read 132 is to read a data block). In response, the metadata extractor 140 sets the completion flag 220 (in data read buffer 180) to indicate that the read call 125 has been completed, but blocks or prevents the second read 132 from actually being executed.

Referring again to FIG. 3, if it is determined at decision block 340 that the read buffer does not include the data read signature (“NO”), the process 300 may continue at block 345, including accessing the load flag for the requested physical block. Decision block 350 may include determining whether the load flag is set to a value (e.g., True) indicating that the requested physical metadata block still needs to be loaded into the metadata cache. If it is determined at decision block 350 that the load flag indicates that the requested physical metadata block has to be (e.g., remains to be) loaded into the metadata cache (“YES”), the process 300 may continue at block 360, including retrieving the physical metadata block from storage, and storing the retrieved physical metadata block in the metadata cache. Block 370 may include setting the load flag to a value (e.g., False) indicating that the requested physical metadata block does not have to be loaded into the metadata cache. After block 370, the process 300 may continue at decision block 395 (described below).

For example, referring to FIGS. 1 and 2B, the metadata extractor 140 receives the first read 131 (from the filesystem layer 130), and then determines that the corresponding metadata read buffer 182 does not include the data read signature 210 (indicating that the first read 131 is to read a metadata block). In response, the metadata extractor 140 reads the load flag 150 that corresponds to the physical metadata block requested by the first read 131. Upon determining that the corresponding load flag 150 is set to a value (e.g., True) that indicates that physical metadata block needs to be loaded into the metadata cache 145, the metadata extractor 140 allows the first read 131 to executed (e.g., by the operating system kernel) to retrieve the physical metadata block from the block-level storage 160. The metadata extractor 140 then populates the retrieved physical metadata block into the metadata cache 145. Further, the metadata extractor 140 sets the corresponding load flag 150 to a value (e.g., False) indicating that the physical metadata block does not need to be loaded into the metadata cache 145.

Referring again to FIG. 3, if it is determined at decision block 350 that the load flag indicates that the requested physical metadata block does not need to be loaded into the metadata cache (“NO”), the process 300 may continue at block 380, including reading the physical metadata block from the metadata cache. After block 380, the process 300 may continue at decision block 395 (described below).

For example, referring to FIGS. 1 and 2B, upon determining that the corresponding load flag 150 is set to a value (e.g., False) that indicates that physical metadata block does not need to be loaded into the metadata cache 145, the metadata extractor 140 reads the physical metadata block from the metadata cache 145.

Referring again to FIG. 3, decision block 395 may include determining whether the file has been complete (i.e., all logical blocks have been processed). If the file has not been completed (“NO”), the process 300 may return to block 315 (i.e., to identify and process the next logical block in the file). Otherwise, if the file has been completed (“YES”), the process 300 may be completed. In some implementations, the process 300 may be repeated for each file in the filesystem (or backup) to be populated into the metadata cache.

For example, referring to FIGS. 1 and 2B, the metadata scanner 120 determines that a read call 125 has been completed, and issues additional read calls 125 to processing the remaining logical blocks and/or files in the filesystem 165. After all files are processed, the metadata cache 145 has been updated to include all of the current metadata blocks in the filesystem 165.

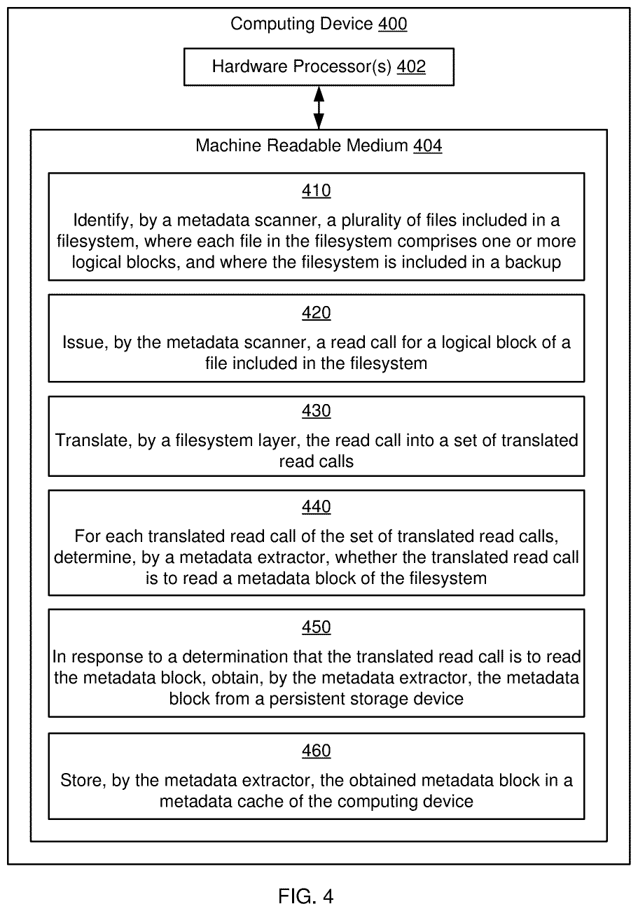

### FIG. 4—Example Computing Device

FIG. 4 shows a schematic diagram of an example computing device 400. In some examples, the computing device 400 may correspond generally to some or all of the computing device 110 (shown in FIG. 1). As shown, the computing device 400 may include a hardware processor 402 and machine-readable storage 405 including instructions 410-460. The machine-readable storage 405 may be a non-transitory medium. The instructions 410-460 may be executed by the hardware processor 402, or by a processing engine included in hardware processor 402.

Instruction 410 may be executed to identify, by a metadata scanner, a plurality of files included in a filesystem, where each file in the filesystem comprises one or more logical blocks, and where the filesystem is included in a backup. For example, referring to FIG. 1, the metadata scanner 120 accesses, from the remote storage 170, a backup 175 including a filesystem 175. The metadata scanner 120 mounts the filesystem 165 on the block-level storage 160. The metadata scanner 120 traverses the mounted filesystem 165 to identify each file in the mounted filesystem 165. Further, the metadata scanner 120 selects a particular file of the mounted filesystem 165, and opens the file using a direct I/O mode. The metadata scanner 120 then uses a filesystem layer 130 to identify the logical data blocks included the selected file.

Referring again to FIG. 4, instruction 420 may be executed to issue, by the metadata scanner, a read call for a logical block of a file included in the filesystem. For example, referring to FIGS. 1-2A, the metadata scanner 120 generates a data read buffer 180 in the user space 155, and issues a read call 125 to request the logical block. The metadata scanner 120 populates the data read buffer 180 with a data read signature 210 and a completion flag 220.

Referring again to FIG. 4, instruction 430 may be executed to translate, by a filesystem layer, the read call into a set of translated read calls. For example, referring to FIGS. 1-2B, the filesystem layer 130 converts the read call 125 into the second read 132 (for a physical data block) and the first read 131 (for a physical metadata block). Further, the filesystem layer 130 generates a metadata read buffer 182 to receive the result of the first read 131.

Referring again to FIG. 4, instruction 440 may be executed to, for each translated read call of the set of translated read calls, determine, by a metadata extractor, whether the translated read call is to read a metadata block of the filesystem. For example, referring to FIGS. 1-2B, the metadata extractor 140 receives the second read 132 (from the filesystem layer 130), and determines that the corresponding data read buffer 180 includes the data read signature 210. Further, the metadata extractor 140 also receives the first read 131 (from the filesystem layer 130), and determines that the corresponding metadata read buffer 182 does not include the data read signature 210 (indicating that the first read 131 is to read a metadata block).

Referring again to FIG. 4, instruction 450 may be executed to, in response to a determination that the translated read call is to read the metadata block, obtain, by the metadata extractor, the metadata block from a persistent storage device. For example, referring to FIGS. 1-2B, in response to determining that the metadata read buffer 182 does not include the data read signature 210, the metadata extractor 140 reads the load flag 150 that corresponds to the physical metadata block requested by the first read 131. Upon determining that the corresponding load flag 150 is set to a value (e.g., True) that indicates that physical metadata block needs to be loaded into the metadata cache 145, the metadata extractor 140 allows the first read 131 to executed (e.g., by the operating system kernel) to retrieve the physical metadata block from the block-level storage 160.

Referring again to FIG. 4, instruction 460 may be executed to store, by the metadata extractor, the obtained metadata block in a metadata cache of the computing device. For example, referring to FIG. 1, the metadata extractor 140 populates the retrieved physical metadata block into the metadata cache 145. Further, the metadata extractor 140 sets the corresponding load flag 150 to a value (e.g., False) indicating that the physical metadata block does not need to be loaded into the metadata cache 145.

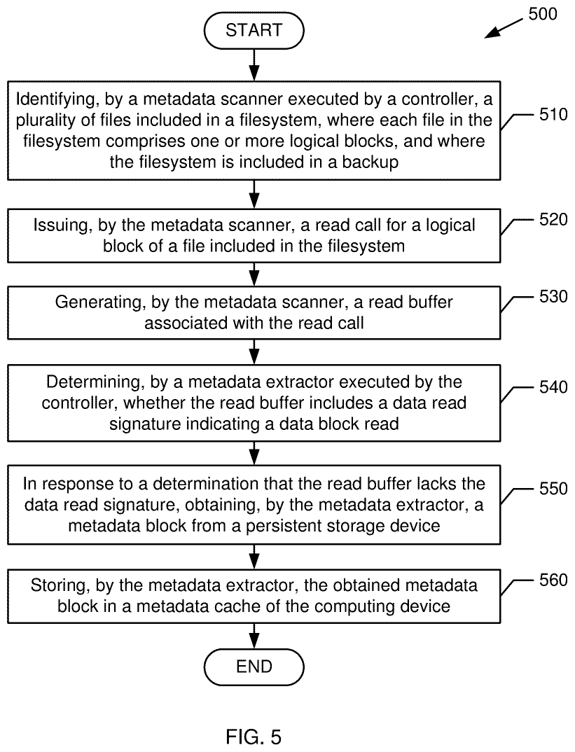

### FIG. 5—Example Process

FIG. 5 shows an example process 500, in accordance with some implementations. In some examples, the process 500 may be performed by a computing device (e.g., the computing device 110 shown in FIG. 1). The process 500 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. However, other implementations are also possible.

Block 510 may include identifying, by a metadata scanner executed by a controller, a plurality of files included in a filesystem, where each file in the filesystem comprises one or more logical blocks, and where the filesystem is included in a backup. For example, referring to FIG. 1, the metadata scanner 120 accesses, from the remote storage 170, a backup 175 including a filesystem 175. The metadata scanner 120 mounts the filesystem 165 on the block-level storage 160. The metadata scanner 120 traverses the mounted filesystem 165 to identify each file in the mounted filesystem 165. Further, the metadata scanner 120 selects a particular file of the mounted filesystem 165, and opens the file using a direct I/O mode. The metadata scanner 120 then uses a filesystem layer 130 to identify the logical data blocks included the selected file.

Referring again to FIG. 5, block 520 may include issuing, by the metadata scanner, a read call for a logical block of a file included in the filesystem. For example, referring to FIG. 1, the metadata scanner 120 generates issues a read call 125 to request a logical data block included the selected file of filesystem 165.

Referring again to FIG. 5, block 530 may include generating, by the metadata scanner, a read buffer associated with the read call. For example, referring to FIGS. 1-2B, the metadata scanner 120 generates a data read buffer 180 in the user space 155, and populates the data read buffer 180 with a data read signature 210 and a completion flag 220. Further, the filesystem layer 130 converts the read call 125 into the second read 132 (for a physical data block) and the first read 131 (for a physical metadata block), and generates a metadata read buffer 182 to receive the result of the first read 131.

Referring again to FIG. 5, block 540 may include determining, by a metadata extractor executed by the controller, whether the read buffer includes a data read signature indicating a data block read. For example, referring to FIGS. 1-2B, the metadata extractor 140 receives the second read 132 (from the filesystem layer 130), and determines that the corresponding data read buffer 180 includes the data read signature 210. Further, the metadata extractor 140 also receives the first read 131 (from the filesystem layer 130), and determines that the corresponding metadata read buffer 182 does not include the data read signature 210 (indicating that the first read 131 is to read a metadata block).

Referring again to FIG. 5, block 550 may include, in response to a determination that the read buffer lacks the data read signature, obtaining, by the metadata extractor, a metadata block from a persistent storage device. For example, referring to FIGS. 1-2B, in response to determining that the metadata read buffer 182 does not include the data read signature 210, the metadata extractor 140 reads the load flag 150 that corresponds to the physical metadata block requested by the first read 131. Upon determining that the corresponding load flag 150 is set to a value (e.g., True) that indicates that physical metadata block needs to be loaded into the metadata cache 145, the metadata extractor 140 allows the first read 131 to executed (e.g., by the operating system kernel) to retrieve the physical metadata block from the block-level storage 160.

Referring again to FIG. 5, block 560 may include storing, by the metadata extractor, the obtained metadata block in a metadata cache of the computing device. For example, referring to FIG. 1, the metadata extractor 140 stores the retrieved physical metadata block into the metadata cache 145. Further, the metadata extractor 140 sets the corresponding load flag 150 to a value (e.g., False) indicating that the physical metadata block does not need to be loaded into the metadata cache 145.

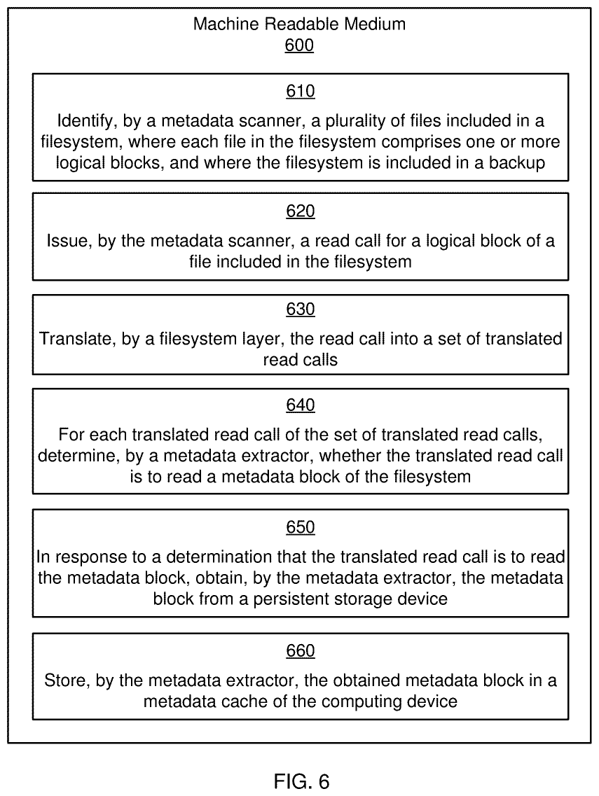

### FIG. 6—Example Machine-Readable Medium

FIG. 6 shows a machine-readable medium 600 storing instructions 610-660, in accordance with some implementations. The instructions 610-660 can be executed by a single processor, multiple processors, a single processing engine, multiple processing engines, and so forth. The machine-readable medium 600 may be a non-transitory storage medium, such as an optical, semiconductor, or magnetic storage medium. The instructions 610-660 may correspond generally to the examples described above with reference to instructions 410-460 (shown in FIG. 4).

Instruction 610 may be executed to identify, by a metadata scanner, a plurality of files included in a filesystem, where each file in the filesystem comprises one or more logical blocks, and where the filesystem is included in a backup. Instruction 620 may be executed to issue, by the metadata scanner, a read call for a logical block of a file included in the filesystem.

Instruction 630 may be executed to translate, by a filesystem layer, the read call into a set of translated read calls. Instruction 640 may be executed to, for each translated read call of the set of translated read calls, determine, by a metadata extractor, whether the translated read call is to read a metadata block of the filesystem.

Instruction 650 may be executed to, in response to a determination that the translated read call is to read the metadata block, obtain, by the metadata extractor, the metadata block from a persistent storage device. Instruction 660 may be executed to store, by the metadata extractor, the obtained metadata block in a metadata cache of the computing device.

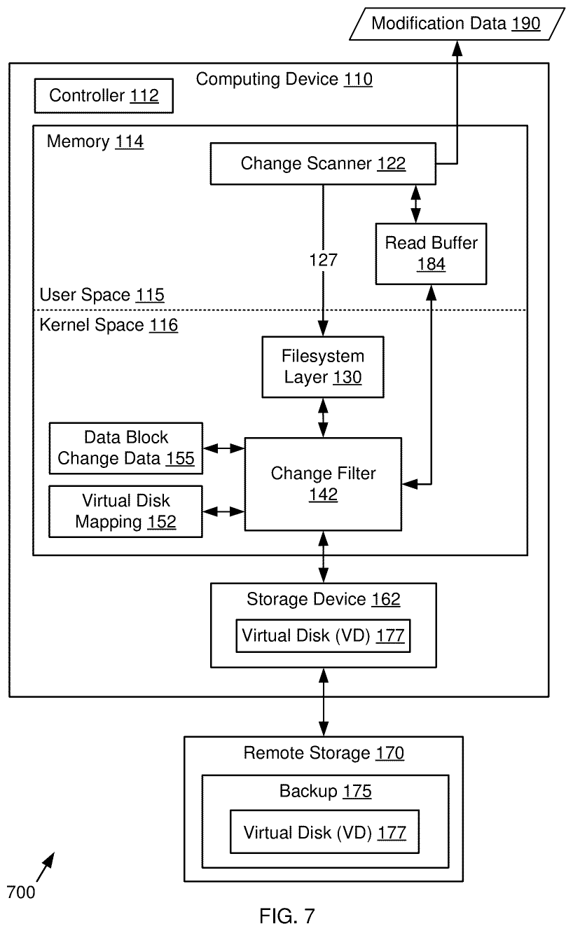

### FIG. 7—Example System

FIG. 7 shows an example system 700, in accordance with some implementations. The system 700 may provide block change information that identifies file-level and block-level modifications to a virtual disk included a backup of a volume. The system 700 may include a computing device 110 and a remote storage 170. In some implementations, the remote storage 170 may store a backup 175 (or multiple backups 175) of a storage volume. Each backup 175 (e.g., a snapshot) may be stored in the form of data blocks, and may include a virtual disk (VD) 177 (or multiple VDs 177). As used herein, a “virtual disk” may be a virtualized representation of a storage device (e.g., a hard disk drive). For example, each VD 177 may be a virtual storage device that is used by a virtual computing device (e.g., a virtual machine (VM)). Further, each VD 177 may be formatted using a virtual machine disk (VMDK) format.

In some implementations, the computing device 110 may include a controller 112, memory 114, and a storage device 162. The storage device 162 may be a physical device that is implemented using non-transitory storage media (e.g., hard disk drives, solid state drives), non-volatile semiconductor memory (e.g., flash memory), and so forth. Further, the computing device 110 may host or execute a change scanner 122, a change filter 142, an operating system (not shown in FIG. 1), and any number of other components. The change scanner 122 and the change filter 142 may be implemented by the controller 112 executing instructions (e.g., software and/or firmware) that are stored in a machine-readable storage medium, in hardware (e.g., circuitry), and so forth. In some implementations, the change scanner 122 may be executed in the user space 115, and the change filter 142 may be executed in the kernel space 116. Further, in some implementations, the kernel space 116 may include a filesystem layer 130. The filesystem layer 130 may be a software component (e.g., interface, driver, kernel module, etc.) that is included in the operating system of the computing device 110, and that translates system calls between applications (e.g., in user space 115) to one or more filesystems (e.g., in kernel space 116).

In some implementations, the combination of the change scanner 122 and the change filter 142 may be executed to identify the files and data blocks that were modified in a given backup 175. In some examples, the change scanner 122 may access a backup 175 stored in the remote storage 170, and may mount, on the storage device 162, a virtual disk 177 included in the backup 175. The change scanner 122 may identify each file in the virtual disk 177 (e.g., by traverse a filesystem of the VD 177). Further, the change scanner 122 may use the filesystem layer 130 to identify the logical blocks (LBs) included each file.

In some implementations, the change scanner 122 may generate or otherwise prepare one or more read buffers 184 in the user space 115. Each read buffer 184 may be configured to receive a different LB included in the identified files. Further, the change scanner 122 may send, to the operating system kernel, one or more read calls 127 to request the LBs included in the identified files. In some implementations, the filesystem layer 130 may receive a read call 127 from the change scanner 122, and may map or translate the LB (requested in the read call 127) to a corresponding virtual disk block (VDB). In some implementations, the VDB may be a virtual representation of a physical block.

In some implementations, a read call 127 may be executed using a direct input/output (I/O) mode or setting. The direct I/O mode may cause the read call 127 to retrieve data directly from storage to a buffer in user space (i.e., without using a buffer in kernel space 116). In some implementations, prior to sending a read call 127 for a given file, the change scanner 122 may initiate the direct I/O mode for the read call 127 by opening the file using a command flag or modifier (e.g., establishing a connection to the file by issuing a Linux “OPEN” system call with an “O_DIRECT” flag).

In some implementations, the change scanner 122 may populate the read buffer 184 (corresponding to the read call 127) with a change signature indicating a block change detection operation. For example, the change signature may be a predefined bit sequence, text string, numerical string, and so forth. In some implementations, the presence of the change signature in the read buffer 184 prevents the normal execution of the read call 127 (e.g., by the operating system) to retrieve the requested logical blocks, and instead causes the change filter 142 to perform a block change detection operation for the requested LBs. Further, the change scanner 122 may also populate the read buffer 184 with a modification flag (e.g., a bit value) that is set to an initial or default value (e.g., a value indicating that the requested logical block was not modified in the backup 175).

In some implementations, the change filter 142 may receive the read call 127 from the filesystem layer 130 (e.g., after the filesystem layer 130 translates the LBs requested in the read call 127 to the corresponding VDBs in the VD 177). In response to receiving the read call 127, the change filter 142 may use the virtual disk (VD) mapping 152 to translate the VDB to a corresponding physical block (PB) on the storage device 162. In some implementations, the VD mapping 152 data may be a data structure that includes multiple entries or records, where each entry maps a different VDB address (i.e., the virtual block address in the VD 177) to a physical block address (i.e., a physical block address in the storage device 162 on which the VD 177 is mounted). For example, in some implementations, the VD mapping 152 data may be generated by executing a management utility for managing virtual disks and storage devices (e.g., the Vmkfstools utility).

In some implementations, the change filter 142 may determine whether the read buffer 184 includes the change signature indicating a block change detection operation. If not, the change filter 142 may allow the read call 127 to be executed to retrieve the requested data blocks from the remote storage 170. Otherwise, if it is determined that the read buffer 184 includes the change signature, the change filter 142 may perform a look-up for the PB in the block change data 155, and may thereby determine whether the PB (i.e., the requested LB) was modified in the backup 175. In some implementations, the block change data 155 may be a stored data structure (e.g., a bitmap) that is generated along with the backup 175 (e.g., by a backup process), and that indicates each data block that was modified by the backup 175 (in comparison to a previous backup).

If the block change data 155 indicates that the requested LB was modified in the backup 175, the change filter 142 may set the modification flag (in the read buffer 184) to indicate that the requested LB was modified in the backup 175. Otherwise, if the change filter 142 determines that the block change data 155 indicates that the requested LB was not modified in the backup 175, the modification flag may be set (or left unchanged if already set) to indicate that the requested LB was not modified in the backup 175.

In some implementations, after issuing a read call 127 for a logical block, the change scanner 122 may read the modification flag in the read buffer 184 to determine whether requested logical block was modified during the backup 175. Further, after processing each file in the backup 175 (e.g., by issuing read calls 127 for all logical blocks), the change scanner 122 may generate modification data 190 (e.g., a report, a list, a database, or other data structure) that identifies each file and/or logical block that was modified during the backup 175. In this manner, the change scanner 122 and the change filter 142 may provide block change information that identifies the modifications to the backup 175 that occur at the data block level.

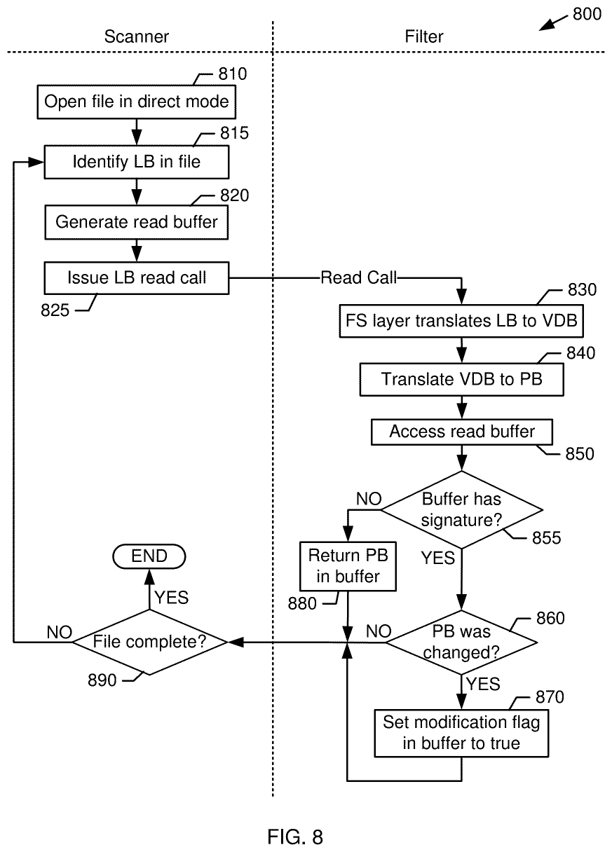

### FIG. 8—Example Process for Generating Block Change Information

FIG. 8 shows an example process 800 for generating block change information, in accordance with some implementations. The process 800 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. As shown in FIG. 8, in some implementations, various actions of the process 800 may be performed by a scanner (e.g., change scanner 122 shown in FIG. 1) and a filter (e.g., change filter 142 shown in FIG. 1). For the sake of illustration, details of the process 800 may be described below with reference to FIG. 7, which shows an example implementation. However, other implementations are also possible.

Block 810 may include opening a file in a direct mode. Block 815 may include identifying a logical block (LB) included in the file. For example, referring to FIG. 7, the change scanner 122 accesses, from the remote storage 170, a backup 175 including a virtual disk (VD) 177. The change scanner 122 mounts the VD 177 on the storage device 162. The change scanner 122 identifies each file in the mounted VD 177 (e.g., by traversing a filesystem in the VD 177). Further, the change scanner 122 selects a particular file of the VD 177, and opens the file using a direct I/O mode (e.g., by issuing an open system call for the file using a command flag to invoke the direct I/O mode). The change scanner 122 then uses a filesystem layer 130 to identify the logical data blocks included the selected file.

Referring again to FIG. 8, block 820 may include generating a read buffer for the logical block. Block 825 may include issuing a read call for the logical block. For example, referring to FIG. 7, the change scanner 122 generates a data read buffer 184 in the user space 155, and issues a read call 127 to request the logical block. The read buffer 184 is configured to receive the logical block that is requested by the read call 127. Further, the change scanner 122 populates the read buffer 184 with a change signature and a completion flag.

Referring again to FIG. 8, block 830 may include the filesystem (FS) layer translating the LB (in the read call) into a virtual disk block (VDB). Block 840 may include the filter translating the VDB into the corresponding physical block (PB). For example, referring to FIG. 7, the FS layer 130 receives the read call 127 from the change scanner 122, and translates the requested LB to a corresponding VDB (on the mounted VD 177). Further, the change filter 142 receives the read call 127 from the filesystem layer 130, and uses the virtual disk (VD) mapping 152 to translate the VDB to a corresponding PB (on the storage device 162).

Referring again to FIG. 8, block 850 may include accessing the read buffer corresponding to the read call. Decision block 855 may include determining whether the read buffer includes a change signature that indicates a block change detection operation. If it is determined that the read buffer does not include the change signature (“NO”), the process 800 may continue at block 880, including obtaining or reading the physical block from persistent storage, and populating the obtained physical block into the read buffer. After block 880, the process 800 may continue at decision block 890 (described below).

For example, referring to FIG. 7, the change filter 142 receives a read call 127 from the filesystem layer 130, and then determines whether the corresponding read buffer 184 includes the change signature. If the read buffer 184 does not include the change signature, the change filter 142 allows the read call 127 to be executed to retrieve the physical block from the VD 177 (mounted on the storage device 162), and to populate the physical block into the read buffer 184.

Referring again to FIG. 8, if it is determined at decision block 855 that the read buffer includes the change signature (“YES”), the process 800 may continue at decision block 860, including determining whether the physical block was modified in the backup. If it is determined at decision block 860 that the physical block was modified in the backup (“YES”), the process 800 may continue at block 870, including setting a modification flag in the read buffer to indicate that the physical block was modified in the backup. After block 870, or if it is determined at decision block 860 that the physical block was not modified in the backup (“NO”), the process 800 may continue at decision block 890 (described below).

For example, referring to FIG. 7, the change filter 142 determines that the read buffer 184 includes the change signature, and in response performs a look-up for the PB in the block change data 155. If the block change data 155 indicates that the PB was changed in the backup 175, the change filter 142 sets the modification flag (in the read buffer 184) to indicate that the requested LB was modified in the backup 175. Otherwise, if the change filter 142 determines that the block change data 155 indicates that the requested LB was not modified in the backup 175, the modification flag is set (or is left unchanged if already set) to indicate that the requested LB was not modified in the backup 175.

Referring again to FIG. 8, decision block 890 may include determining whether the file has been complete (i.e., all logical blocks have been processed). If the file has not been completed (“NO”), the process 800 may return to block 815 (i.e., to identify and process the next logical block in the file). Otherwise, if the file has been completed (“YES”), the process 800 may be completed. In some implementations, the process 800 may be repeated for each file in the virtual disk (or multiple virtual disks) of the backup. Further, after performing the process 800 for all files in the virtual disk(s), the modification flags (in the read buffers) may be used to generate a modification report that identifies each file and/or logical block that was modified during the backup.

For example, referring to FIG. 7, after issuing the read call 127 for the logical block, the change scanner 122 reads the modification flag in the read buffer 184, to determine whether the logical block was modified during the backup 175. Further, after processing each file in the VD(s) 177 of the backup 175 (e.g., by issuing read calls 127 for all logical blocks), the change scanner 122 generates modification data 190 that identifies each file and/or logical block that was modified in the VD(s) 177 during the backup 175. In this manner, the change scanner 122 and the change filter 142 may provide block change information that identifies the modifications in the VD(s) 177 that occur at the data block level.

### CONCLUSION

In some implementations, a first computing device may execute a scanner and an extractor to generate a local metadata cache. The local metadata cache includes only the metadata blocks of a filesystem that is stored in a backup. The scanner may identify each file in a filesystem, and may issue data reads to retrieve the data blocks in the identified files. Further, the scanner may generate a read buffer for each data read, and may write a metadata signature into each read buffer. A filesystem layer of the computing device may receive the data reads, and may generate metadata reads and their respective read buffers. The extractor receives each (metadata and data) read, and determines whether the corresponding read buffer includes the metadata signature. If the metadata signature is present in the read buffer (e.g., for a data read), the extractor sets a flag to mark the corresponding data read as complete without retrieving the requested data block. Otherwise, if the metadata signature is not present in the read buffer (e.g., for a metadata read), the extractor reads the corresponding metadata block from the stored backup, and then stores the metadata block in the metadata cache. In this manner, the computing device populates the metadata cache with the metadata blocks of the filesystem, but does not read the data blocks of filesystem. Accordingly, the disclosed technique may reduce the processing time and networking bandwidth needed to obtain the metadata blocks of the filesystem stored in the backup.

Further, in other implementations, a second computing device may execute a change scanner and a change filter to determine which files and data blocks have been modified in a virtual disk (VD) stored in a backup. The change scanner may identify each file in a VD, and may issue read calls to retrieve the logical blocks (LBs) in the identified files. Further, the change scanner may write a change signature into the read buffers for the read calls. A filesystem layer of the computing device may translate the LBs (in the rad calls) into virtual disk blocks (VDBs). The change filter may intercept each read call, and use a virtual disk mapping structure to translate the VDB (in the read call) to a physical block (PB). The change filter may determine whether the change signature is present in the read buffer associated with the read call. If the change signature is present in the read buffer, the change filter determines whether the requested PB was modified in a recent backup. If so, the change filter may populate the read buffer with block change information indicating that the PB was modified in the backup. The change scanner may obtain the block change information from the read buffer, and may use this information to generate a modification report. In this manner, some implementations may provide block change information that identifies modifications to files in the VD that occur at the data block level.

Note that, while FIGS. 1-8 show various examples, implementations are not limited in this regard. For example, referring to FIGS. 1 and 7, it is contemplated that the systems 100, 700 may include additional devices and/or components, fewer components, different components, different arrangements, and so forth. In another example, it is contemplated that the functionality of the computing device 110 described above may be included in any another engine or software of the systems 100, 700. Other combinations and/or variations are also possible.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

What is claimed is:

1. A computing device comprising:
a controller; and
a machine-readable storage storing instructions, the instructions executable by the processor to:
identify, by a metadata scanner, a plurality of files included in a filesystem, wherein each file in the filesystem comprises one or more logical blocks, and wherein the filesystem is included in a backup;
issue, by the metadata scanner, a read call for a logical block of a file included in the filesystem;
translate, by a filesystem layer, the read call into a set of translated read calls;
for each translated read call of the set of translated read calls, determine, by a metadata extractor, whether the translated read call is to read a metadata block of the filesystem;
in response to a determination that the translated read call is to read the metadata block, obtain, by the metadata extractor, the metadata block from a persistent storage device; and
store, by the metadata extractor, the obtained metadata block in a metadata cache of the computing device.

2. The computing device of claim 1, wherein the set of translated read calls comprises a data read and a metadata read.

3. The computing device of claim 2, including instructions executable by the controller to:
generate, by the metadata scanner, a data read buffer to receive a result of the data read;
populate, by the metadata scanner, a data read signature into the data read buffer; and
generate, by the metadata scanner, a metadata read buffer to receive a result of the metadata read.

4. The computing device of claim 3, including instructions executable by the controller to:
receive, by the metadata extractor, the data read from the filesystem layer;
in response to a receipt of the data read, determine, by the metadata extractor, whether the data read buffer includes the data read signature; and
in response to a determination that the data read buffer includes the data read signature, determine that the data read is not to read the metadata block.

5. The computing device of claim 4, including instructions executable by the controller to:
in response to a determination that the data read is not to read the metadata block, set, by the metadata extractor, the data read as completed, wherein the data read is not executed.

6. The computing device of claim 3, including instructions executable by the controller to:
receive, by the metadata extractor, the metadata read from the filesystem layer;
in response to a receipt of the metadata read, determine, by the metadata extractor, whether the metadata read buffer includes the data read signature; and
in response to a determination that the metadata read buffer does not include the data read signature, determine that the read call is to read the metadata block.

7. The computing device of claim 6, including instructions executable by the controller to:
in response to the determination that the read call is to read the metadata block, determine whether the metadata block has to be loaded into the metadata cache; and
in response to a determination that the metadata block has to be loaded into the metadata cache, obtain the metadata block from the persistent storage device.

8. The computing device of claim 7, including instructions executable by the controller to:
in response to the determination that the read call is to read the metadata block, perform a look-up of the metadata block in a set of load flags, wherein the set of load flags indicate which blocks remain to be loaded in the metadata cache; and
determine, based on the look-up of the metadata block in the set of load flags, that the metadata block has to be loaded into the metadata cache.

9. The computing device of claim 1, including instructions executable by the controller to:
prior to issuing the read call, issue, by the metadata scanner, an open system call for the file using a command flag to invoke a direct input/output (I/O) mode.

10. The computing device of claim 1, wherein the metadata scanner is executed in a user space of a system memory of the computing device, and wherein the metadata filter is executed in a kernel space of the system memory.

11. A method comprising:
identifying, by a metadata scanner executed by a controller, a plurality of files included in a filesystem, wherein each file in the filesystem comprises one or more logical blocks, and wherein the filesystem is included in a backup;
issuing, by the metadata scanner, a read call for a logical block of a file included in the filesystem;
generating, by the metadata scanner, a read buffer associated with the read call;
determining, by a metadata extractor executed by the controller, whether the read buffer includes a data read signature indicating a data block read;
in response to a determination that the read buffer lacks the data read signature, obtaining, by the metadata extractor, a metadata block from a persistent storage; and
storing, by the metadata extractor, the obtained metadata block in a metadata cache of the computing device.

12. The method of claim 11, comprising:
in response to a determination that the read buffer includes the data read signature, marking, by the metadata extractor, the data read as completed, wherein the data read is not executed.

13. The method of claim 11, comprising:
translating, by a filesystem layer, the read call into a data read and a metadata read;
generating, by the metadata scanner, a data read buffer to receive a result of the data read;
populating, by the metadata scanner, a data read signature into the data read buffer; and
generating, by the metadata scanner, a metadata read buffer to receive a result of the metadata read, wherein the read buffer is one of the data read buffer and the metadata read buffer.

14. The method of claim 11, comprising:
in response to the determination that the read buffer lacks the data read signature, determining whether the metadata block has to be loaded into the metadata cache; and
in response to a determination that the metadata block has to be loaded into the metadata cache, obtaining the metadata block from the persistent storage device.

15. The method of claim 11, comprising:
prior to issuing the read call, issuing, by the metadata scanner, an open system call for the file using a command flag to invoke a direct input/output (I/O) mode.

16. A non-transitory machine-readable medium storing instructions that upon execution cause a controller to:
identify, by a metadata scanner, a plurality of files included in a filesystem, wherein each file in the filesystem comprises one or more logical blocks, and wherein the filesystem is included in a backup;
issue, by the metadata scanner, a read call for a logical block of a file included in the filesystem;
translate, by a filesystem layer, the read call into a set of translated read calls;
for each translated read call of the set of translated read calls, determine, by a metadata extractor, whether the translated read call is to read a metadata block of the filesystem;
in response to a determination that the translated read call is to read the metadata block, obtain, by the metadata extractor, the metadata block from a persistent storage device; and
store, by the metadata extractor, the obtained metadata block in a metadata cache of the computing device.

17. The non-transitory machine-readable medium of claim 16, including instructions that upon execution cause the controller to:
in response to a determination that the translated read call is not to read the metadata block, mark the data read as completed, wherein the data read is not executed.

18. The non-transitory machine-readable medium of claim 16, including instructions that upon execution cause the controller to:
translate, by a filesystem layer, the read call into a data read and a metadata read;
generate, by the metadata scanner, a data read buffer to receive a result of the data read;
populate, by the metadata scanner, a data read signature into the data read buffer; and
generate, by the metadata scanner, a metadata read buffer to receive a result of the metadata read.

19. The non-transitory machine-readable medium of claim 18, including instructions that upon execution cause the controller to:
receive, by the metadata extractor, the data read from the filesystem layer;
in response to a receipt of the data read, determine, by the metadata extractor, whether the data read buffer includes the data read signature; and
in response to a determination that the data read buffer includes the data read signature, determine that the data read is not to read the metadata block.

20. The non-transitory machine-readable medium of claim 16, including instructions that upon execution cause the controller to:
in response to the determination that the read call is to read the metadata block, perform a look-up of the metadata block in a set of load flags, wherein the set of load flags indicate which blocks remain to be loaded in the metadata cache;
determine, based on the look-up of the metadata block in the set of load flags, whether the metadata block has to be loaded into the metadata cache; and
in response to a determination that the metadata block has to be loaded into the metadata cache, obtain the metadata block from the persistent storage device.
